(19) United States
(12) Patent Application Publication
(10) Pub. No.: US 2007/0094273 A1
(43) Pub. Date: Apr. 26, 2007

(54) System topology for secure end-to-end communications between wireless device and application data source

(76) Inventors: Brindusa Fritsch, Toronto (CA); Michael Shenfield, Richmond Hill (CA); Viera Bibr, Kilbride (CA)

Correspondence Address: Gowling Lafleur Henderson LLP, 2600-160 Elgin Street, Ottawa, ON, K1P 1C3, CA

(21) Appl. No.: 11/405,583

(22) Filed: Apr. 18, 2006

Related U.S. Application Data
(60) Provisional application No. 60/672,019, filed on Apr. 18, 2005.

(51) Int. Cl. G06F 17/30

(52) U.S. Cl. 707/10

(57) ABSTRACT

A secure end-to-end messaging system and a method of providing secure end-to-end communication between a wireless device and an application data source are provided. The secure end-to-end messaging system comprises a default application gateway (AG) for communicating with local application data sources and/or external application data sources that do not require secure communication, and a dedicated application gateway for securely communicating with external application data sources that require secure communication. The method comprises the steps of receiving instructions from an application to send communication message from a wireless or mobile device to a back-end service, determining whether the application is associated with a dedicated AG, sending the communication messages via a default AG if the application is not associated with a dedicated AG and sending the communication messages via a dedicated application gateway if the application is not associated with the dedicated AG. A system topology for secure communications between application data sources and wireless devices is also provided. The system topology comprises a default application gateway for communicating local or non-secure back-end services with a device and a dedicated application gateway for communicating external and secure back-end services with the device.

This non-provisional application claims benefit of U.S. Provisional Application No. 60/672,019 filed Apr. 18, 2005, which is hereby incorporated by reference.

The present patent disclosure relates generally to a communication system for providing communication to a plurality of devices and specifically to a system topology for secure end-to-end communications between wireless devices and application data sources.

### BACKGROUND

A general concern in communications systems is security. Overhead associated with security features such as virtual private networks and encryption techniques may be too high for devices with restricted physical resources or limited transmission bandwidth. However the allowing access to services such as Web services requires secure communication, regardless of the type of device used.

A systems topologies disclosed herein provide a communication system for secure end-to-end communications to obviate or mitigate at least some of the aforementioned disadvantages.

### BRIEF DESCRIPTION OF THE DRAWINGS

An embodiment of the patent disclosure will now be described by way of example only with reference to the following drawings in which:

FIG. 1 is block diagram of a network facilitating wireless component applications;

FIG. 2 illustrates in a block diagram a topology for an application gateway in a corporation domain in accordance with an embodiment of the present patent disclosure;

FIG. 3 shows in a component diagram an example of a secure messaging system for providing secure end-to-end communication between a wireless device and an application data source, in accordance with an embodiment of the present patent disclosure;

FIG. 4 shows in a flowchart an example of a method of providing secure end-to-end communication between a wireless device and an application data source, in accordance with an embodiment of the secure messaging system;

FIG. 5 illustrates in a block diagram a topology for an application gateway in a corporation domain with a dedicated domain in accordance with an embodiment of the secure messaging system;

FIG. 6 illustrates in a block diagram a topology for an application gateway in two corporation domains with a dedicated domain in accordance with an embodiment of the secure messaging system;

FIG. 7 illustrates in a block diagram a topology for an application gateway in a public domain in accordance with an embodiment of the secure messaging system;

FIG. 8 illustrates in a block diagram a topology for an application gateway in a public domain with a dedicated domain in accordance with an embodiment of the secure messaging system; and

FIG. 9 illustrates in a block diagram a topology for an application gateway in two public domains with a dedicated domain in accordance with an embodiment of the secure messaging system.

### DETAILED DESCRIPTION OF THE PREFERRED EMBODIMENT

In accordance with an aspect of the present patent disclosure there is provided a secure end-to-end messaging system for providing secure end-to-end communication between a wireless device and an application data source. The secure end-to-end messaging system comprises a default application gateway (AG) for communicating with local application data sources and/or external application data sources that do not require secure communication, and a dedicated application gateway for securely communicating with external application data sources that require secure communication.

In accordance with another aspect of the present patent disclosure there is provided a method of providing secure end-to-end communication between a wireless device and an application data source. The method comprises the steps of receiving instructions from an application to send communication message from a wireless or mobile device to a back-end service, determining whether the application is associated with a dedicated AG, sending the communication messages via a default AG if the application is not associated with a dedicated AG and sending the communication messages via a dedicated application gateway if the application is not associated with the dedicated AG.

In accordance with another aspect of the present patent disclosure there is provided a system topology for secure communications between application data sources and wireless devices. The system topology comprises a default application gateway for communicating local or non-secure back-end services with a device and a dedicated application gateway for communicating external and secure back-end services with the device.

In accordance with another aspect of the present patent disclosure there is provided a computer-readable medium storing instructions or statements for use in the execution in a computer of a method of providing secure end-to-end communication between a wireless device and an application data source. The method comprises the steps of receiving instructions to send a communication message from a wireless or mobile device to a back-end service, determining whether the application calling the back-end service is associated with a dedicated application gateway, sending the communication messages via a default application gateway if the application is not associated with the dedicated application gateway and sending the communication messages via the dedicated application gateway if the application is associated with the dedicated application gateway.

In accordance with another aspect of the present patent disclosure there is provided a propagated signal carrier carrying signals containing computer-executable instructions that can be read and executed by a computer. The computer-executable instructions are used to execute a method of providing secure end-to-end communication between a wireless device and an application data source. The method comprises the steps of receiving instructions to send a communication message from a wireless or mobile device to a back-end service, determining whether the application calling the back-end service is associated with a dedicated application gateway, sending the communication messages via a default application gateway if the application is not associated with the dedicated application gateway and sending the communication messages via the dedicated application gateway if the application is associated with the dedicated application gateway.

An advantage of the present secure topology is the ability to provide secure communication end-to-end without any gap. The encrypted message from the mobile device is delivered to the dedicated application gateway (AG), located within the service provider firewall.

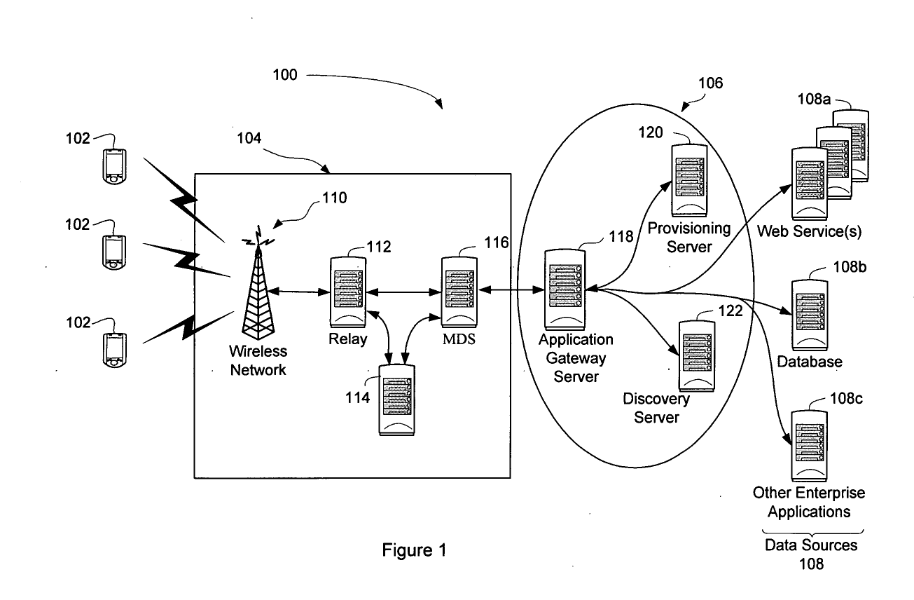

For convenience, like numerals in the description refer to like structures in the drawings. Referring to FIG. 1, a communication infrastructure is illustrated generally by numeral 100. The communication infrastructure 100 comprises a plurality of wireless devices 102, a communication network 104, an application gateway 106, and a plurality of backend services 108.

The wireless devices 102 are typically personal digital assistants (PDAs), such as a Blackberry™ by Research in Motion for example, but may include other devices. Each of the wireless devices 102 includes a runtime environment (RE) capable of hosting a plurality of component applications.

Component applications comprise one or more data components, presentation components, and/or message components, which are written in a structured definition language such as Extensible Markup Language (XML). The component applications can further comprise workflow components which contain a series of instructions such as written in a subset of ECMAScript, and can be embedded in the XML in some implementations. Therefore, since the applications are compartmentalized, a common application can be written for multiple devices by providing corresponding presentation components without having to rewrite the other components. Further, large portions of the responsibility of typical applications are transferred to the runtime environment for the component application.

The wireless devices 102 are in communication with the application gateway 106 via the communication network 104. Accordingly, the communication network 104 may include several components such as a wireless network 110, a relay 112, a corporate device server 114 and/or a mobile data server 116 for relaying data between the wireless devices 102 and the application gateway 106.

The application gateway 106 comprises a gateway server 118 a provisioning server 120 and a discovery server 122. The gateway server 118 acts as a message broker between the runtime environment on the wireless devices 102 and the back-end services 108. The gateway server 118 is in communication with both the provisioning server 120 and the discovery server 122. The gateway server 118 is further in communication with a plurality of the back-end services 108, such as Web services 108a, database services 108b, as well as other enterprise services 108c, via a suitable link. For example, the gateway server 118 is connected with the Web services 108a and database services 108b via Simple Object Access Protocol (SOAP) and Java Database Connectivity (JDBC) respectively. Other types of back-end services 108 and their corresponding links will be apparent to a person of ordinary skill in the art.

Each wireless device 102 is initially provisioned with a service book establishing various protocols and settings, including connectivity information for the corporate server 114 and/or the mobile data server 116. These parameters may include a Uniform Resource Locator (URL) for the application gateway server 118 as well as its encryption key. Alternately, if the wireless device 102 is not initially provisioned with the URL and encryption key, they may be pushed to the wireless device 102 via the mobile data server 116. The mobile device 102 can then connect with the application gateway 106 via the URL of the application gateway server 118.

A provisioning service and a discovery service are provided by the provisioning server 120 and discovery server 120, respectively. An application gateway services layer provides wireless component application domain-specific services. These services provide efficient message transformation and delivery to backend services 108 and provide wireless device 102 and component application lifecycle management.

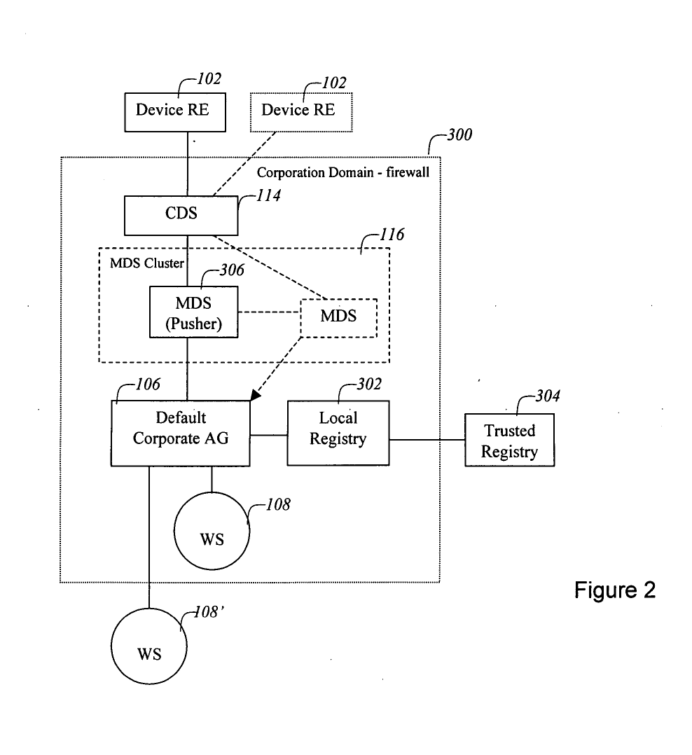

Referring to FIG. 2, there is illustrated in a block diagram a topology for an application gateway in a corporation domain, in accordance with an embodiment of the present patent disclosure. The topology includes a corporation domain 300 behind a firewall with a corporate application gateway (AG) 106, a corporate device server 114, a mobile device server (MDS) 116, a local registry 302, and a Web service 108. Outside the corporate domain are a trusted registry (optional) 304 and another Web service 108′.

Preferably, the corporate domain server 114 is configured and responsible for providing secure communication between device RE and Corporation domain. Preferably, if the corporate domain server 114 is not present, AG can provide secure communication with the device. In a corporation domain, a corporation system administrator publishes a component application in local registry 302. Or an authorized user of a trusted registry publishes the component application in trusted registries 304. Preferably, the component application is provisioned only through default corporate AG. A security handshake (for example, a security key exchange) will take place between the device and an AG when the application is provisioned. This exchange of security keys allows for encryption.

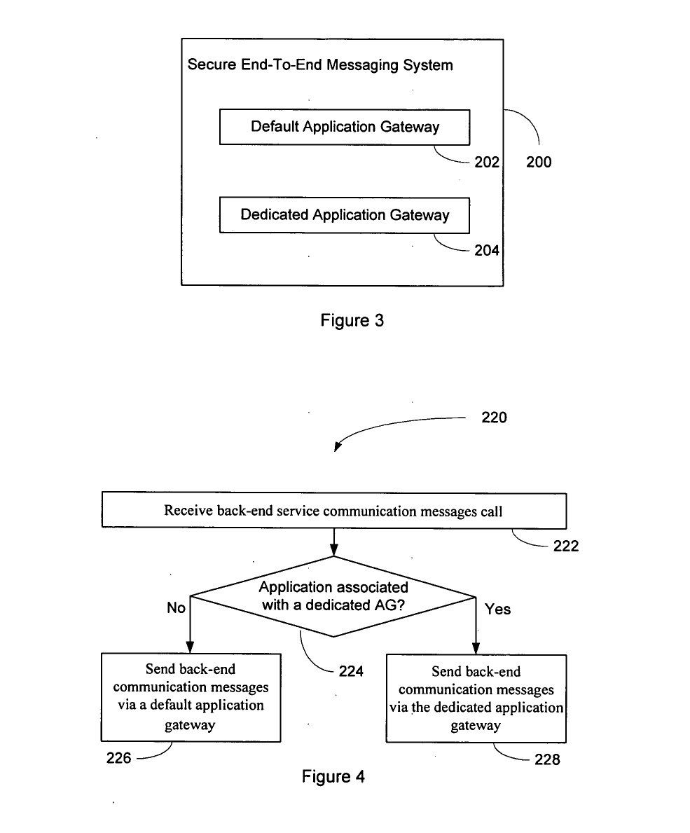

FIG. 3 shows in a component diagram an example of a secure end-to-end messaging system 200 for providing secure end-to-end communication between a wireless device and an application data source, in accordance with an embodiment of the present patent disclosure. The secure messaging system 200 comprises a default application gateway (AG) for communicating with local application data sources and/or external application data sources that do not require secure communication, and a dedicated application gateway for securely communicating with external application data sources that require secure communication. If the application requires secure communication, then its configuration would have been set to be associated with a dedicated AG 204. If no dedicated AG 204 is configured for the application, then the default AG 202 is used for communication for the application (or back-end service). For example, if the application on a device 102 is requesting a Web service (or any other back-end service) from an external domain, and the application requesting the Web service is associated with a dedicated AG 204, then the AG 204 will be used for the communication between the device and that Web service. If the Web service is local (within the same domain firewall) or if a dedicated AG 204 is not associated with the application, the default AG 202 will be used for that Web service communication. Other components may be added to the secure messaging system 200, including a registry of dedicated AGs 204 associated with external back-end services can be maintained to determine and locate the appropriate dedicated AG 204.

Advantageously, the introduction of a dedicated AG 204 provided end-to-end secure communications for an application on a device 102. Since the dedicated AG 204 is located within firewall of an application data source, there is no gap in secure data transmission. An application can be associated with a dedicated AG 204 hosted by the service provider and thus provide end-to-end security.

FIG. 4 shows in a flowchart an example of a method of providing secure end-to-end communication between a wireless device and an application data source (220), in accordance with an embodiment of the secure messaging system 200. The method (220) begins with the device receiving instructions to send a communication message to a back-end service (222). Next the device determines if the application calling the back-end service is associated with a dedicated AG 204 (224). If the application is not associated with a dedicated AG 204 (224), then the communication message is sent via a default AG 202 (226). If application calling the back-end service is associated with a dedicated AG 204 (224), then the communication message is sent via that dedicated AG 204. The application that calls the back-end service is configured upon provisioning with the dedicated AG 204 to use for secure communication. Other steps may be added to this method, including storing a plurality of dedicated AG 204 addresses, and exchanging security keys between the device and dedicated AG 204 when an application is provisioned. The exchange of security keys allows for end-to-end encryption.

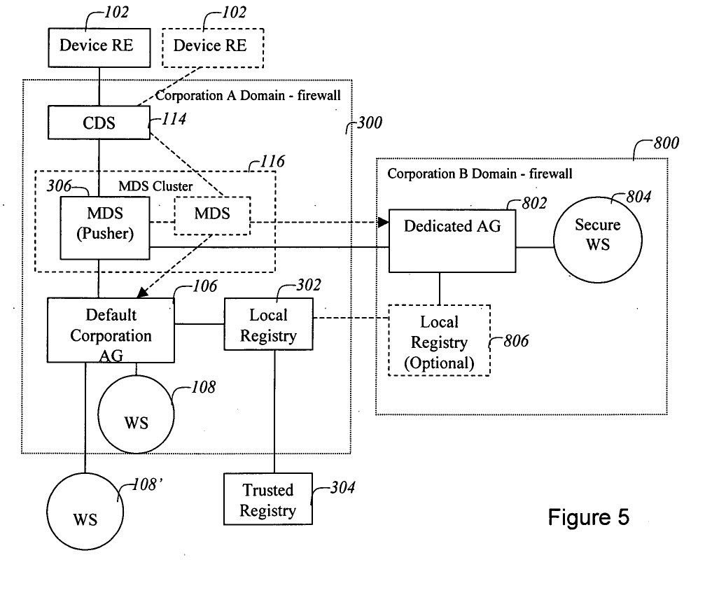

Referring to FIG. 5, there is illustrated in a block diagram a topology for an application gateway in a corporation domain with a dedicated domain, in accordance with an embodiment of the secure messaging system. The topology includes a corporation domain 300 behind firewall with corporate application gateway (AG) 106, a corporate device server 114, a mobile device server (MDS) 116, a local registry 302, and a Web server 108. Outside the corporate domain are a trusted registry (optional) 304 and another Web server 108′. The topology also includes a second corporate domain 800, corporation B, behind a firewall. The second corporate domain 800 includes a dedicate AG 802, a secure Web server 804 and an optional local registry 806.

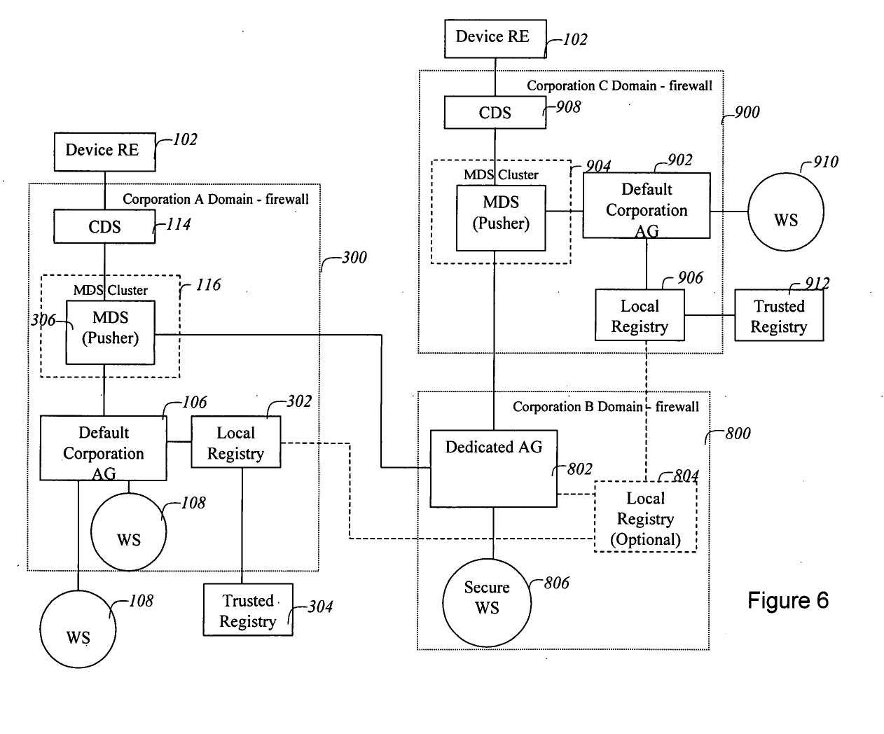

Referring to FIG. 6, there is illustrated in a block diagram a topology for an application gateway in two corporation domains with a dedicated domain in accordance with an embodiment of the secure messaging system. FIG. 6 shows an extension of FIG. 5 to include a third corporate domain 900 connected to the second corporate domain 800. The third corporate domain 900 corporate includes a default corporate application gateway (AG) 902, a mobile device server (MDS) 904, a local registry 906, and a corporate device server 908. Outside the corporate domain are a Web server 910 and a trusted registry 912.

In the model of FIGS. 5 and 6, corporation B (800) allows all devices of corporation A (300) to access a secure component application served only from the dedicated AG 802, which is in domain 800 of Corporation B. The component application requests secure communication among devices 102, the dedicated AG 802, and the secure Web service 804. Firewalls between two corporation domains are configured in such way that communication between the MDS (MDS cluster) 116 in Corporation A domain 300 and the dedicated AG 802 in Corporation B domain 800 is allowed.

An optional local registry 806 could be deployed with the dedicated AG 802 in Corporation B domain 800. In such case, the registry 806 in Corporation B domain should be configured as a trusted registry of local registry 302 in domain 300 of Corporation A. In case of MDS cluster, devices 102 communicate with a wireless component application AG (default Corporation AG 106 or dedicated AG 802) through different dedicated MDS in the cluster 116. A wireless component application AG pushes messages to devices 102 through a unique MDS (Pusher) 306 pre-configured in cluster.

Preferably:
The CDS 114 in domain of Corporation A is configured and responsible for providing secure communication between device RE 102 and Corporation domain 300.
The local registry 302 is configured to allow working with a list of trusted registries 304. When the trusted registries list is empty, only local registry is allowed.
The component application published in registry is always trusted.
Corporation B allows all devices 102 registered with Corporation A to access a secure component application deployed on a dedicated AG 802 within Corporation B domain 800.
Certificate of dedicate AG 802 is provided to default AG 106 in Corporation A domain.
The default AG has an overall view of the device and can administer the device privileges and content. Preferably, the dedicated AG only views and manges its own component application.

Two component application publishing models are supported in the topology of FIGS. 5 and 6.

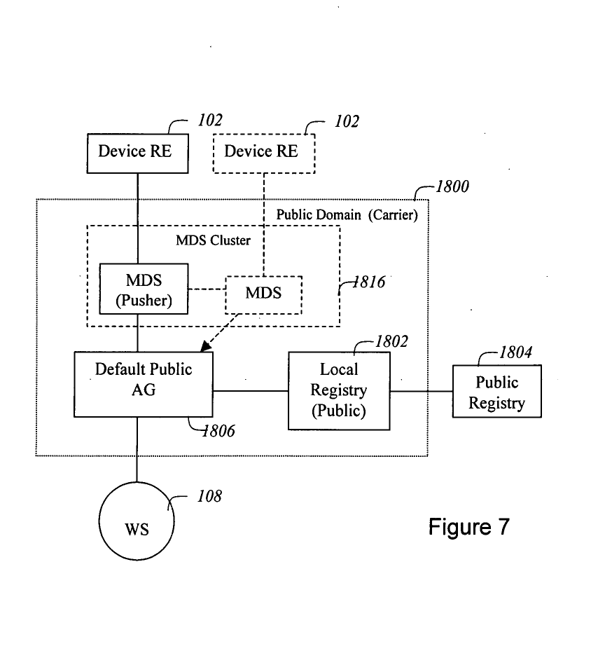

Referring to FIG. 7, there is illustrated in a block diagram a topology for an application gateway in a public domain, in accordance with an embodiment of the secure messaging system. The topology includes a public domain 1800 with default public application gateway (AG) 1806, a mobile device server (MDS) 1816, a local registry 1802, a public registry 1804 and a Web server 108. In this model, wireless component application AG is deployed within a public (carrier) domain 1800 with MDS 1816, Local Registry (Public) 1802. The Public Registry 1802 could be configured to work with other registries. Preferably, secure communication with devices is provided by the AG 106.

In case of an MDS cluster, devices 102 communicate with a wireless component application AG 1806 through different dedicated MDS in the cluster. A wireless component application AG 1806 pushes messages to devices 102 through a unique MDS (Pusher) 1806 pre-configured in cluster 1816.

Preferably:
Secure end-to-end communication is provided via a dedicated AG within the back-end firewall. The communication between AG 106 and device 102 is secured or encrypted.
Local registry (public) is configured to allow working with any public registry or a list of trusted registries.
Default public AG could maintain a list of trusted certificates.
Default public AG security policy could be configured to support
   i. Only trusted component application (with trusted certificate) be provisioned
   ii. Allow component application provisioning without certificate or unknown certificate
Security profile on device could be configured to allow or disallow un-trusted component application.
   Public registry administrator or authorized registry user publishes a component application in public registry. The component application could be signed with publisher's certificate, or without certificate.

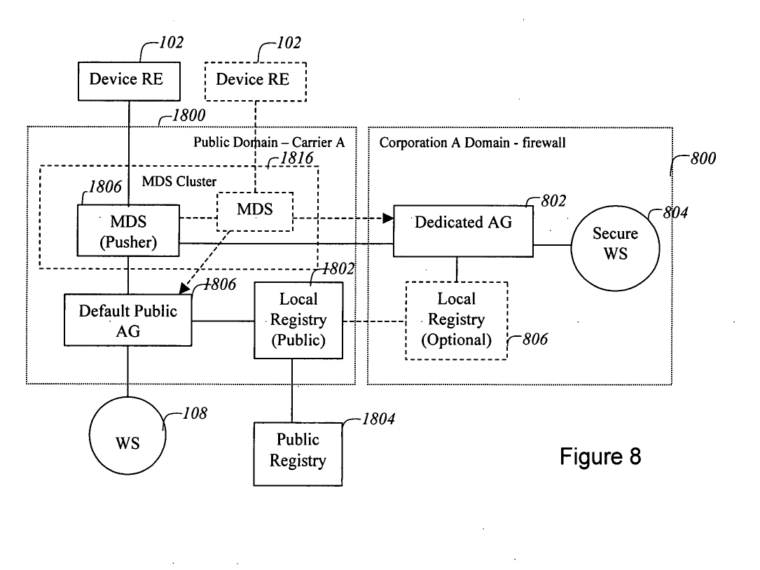

Referring to FIG. 8, there is illustrated in a block diagram a topology for an application gateway in a public domain with a dedicated domain, in accordance with an embodiment of the secure messaging system. The topology includes a public domain 1800 with public application gateway (AG) 1806, a mobile device server (MDS) 1816, a local public registry 1802, and a Web server 108. Also couple to the public domain are a trusted registry 1804 and a Web server 108. The topology also includes a corporate domain 800, corporation A, behind a firewall. The corporate domain 800 includes a dedicate AG 802, a secure Web server 804 and an optional local registry 806.

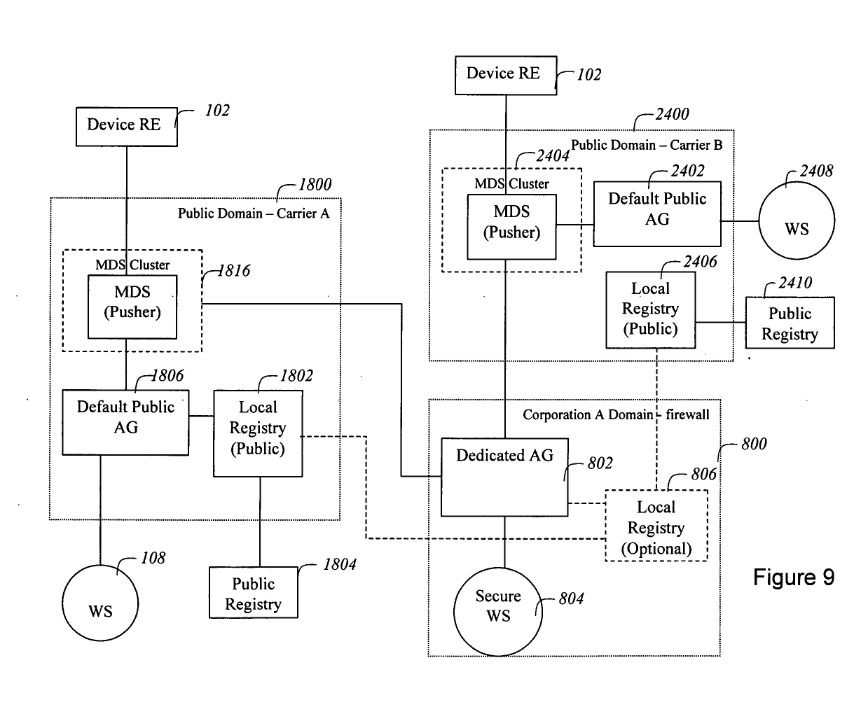

Referring to FIG. 9, there is illustrated in a block diagram a topology for an application gateway in two public domains with a dedicated domain, in accordance with an embodiment of the secure messaging system. FIG. 9 shows an extension of FIG. 8 to include a second public domain 2400 connected to the corporate domain 800. The second public domain 2400 includes a default public application gateway (AG) 2402, a mobile device server (MDS) 2404, and a local registry 2406. Outside the second public domain are a Web server 2408 and a public registry 2410.

In the model of FIGS. 8 and 9, corporation A (800) allows all devices of carrier A (1800) to access a secure component application served only from the dedicated AG 802, which is in domain 800 of Corporation A. The component application requests secure communication among devices 102, the dedicated AG 802, and the secure Web service 804. Firewalls between carrier and corporate domains are configured in such way that communication between the MDS in carrier domains and the dedicated AG 802 in corporation A domain 800 is allowed.

An optional local registry 806 could be deployed with the dedicated AG 802 in Corporation A domain 800. In such case, the registry 806 in Corporation A domain should be configured as a trusted registry of local public registries 1802 and 2406 in public domains 1800 and 2400 respectively. In case of MDS cluster, devices 102 communicate with a wireless component application AG (default public AG (1806 and 2402) or dedicated AG 802) through different dedicated MDS in the cluster 116. A wireless component application AG pushes messages to devices 102 through a unique MDS (Pusher) pre-configured in cluster.

The system and methods according to the present patent disclosure may be implemented by any hardware, software or a combination of hardware and software having the above described functions. The software code, either in its entirety or a part thereof, may be stored in a computer readable memory. Further, a computer data signal representing the software code which may be embedded in a carrier wave may be transmitted via a communication network. Such a computer readable memory and a computer data signal are also within the scope of the present patent disclosure, as well as the hardware, software and the combination thereof.

While particular embodiments of the present patent disclosure have been shown and described, changes and modifications may be made to such embodiments without departing from the true scope of the patent disclosure.

What is claimed is:

1. A secure end-to-end messaging system for providing secure end-to-end communication between a wireless device and an application data source, the secure messaging system comprising:
a default application gateway for communicating with local application data sources and with external application data sources that do not require secure communication; and
a dedicated application gateway for securely communicating with application data sources that require secure communication.

2. The secure messaging system as claimed in claim 1, further comprising a plurality of dedicated application gateways for securely communicated with a plurality of application data sources.

3. The secure messaging system as claimed in claim 1, further comprising a registry of dedicated application gateways associated with external application data sources.

4. A method of providing secure end-to-end communication between a wireless device and an application data source, the method comprising the steps of:
receiving instructions to send a communication message from a wireless or mobile device to a back-end service;
determining whether the application calling the back-end service is associated with a dedicated application gateway;
sending the communication messages via a default application gateway if the application is not associated with the dedicated application gateway; and
sending the communication messages via the dedicated application gateway if the application is associated with the dedicated application gateway.

5. The method as claimed in claim 4, further comprising the step of:
determining the dedicated application gateway to associate with the back-end service.

6. The method as claimed in claim 4, further comprising the step of:
sending the communication to a back-end service within a local domain.

7. The method as claimed in claim 4, further comprising the step of:
sending the communication to a back-end service to an external domain.

8. A system topology for secure communications between application data sources and wireless devices, the system comprising:
a default application gateway for communicating with local application data sources and with external application data sources that do not require secure communication; and
a dedicated application gateway for securely communicating with application data sources that require secure communication.

9. The system topology as claimed in claim 8, wherein the communication between the dedicated gateway and the device is secured.

10. The system topology as claimed in claim 8, wherein the dedicated application gateway is protected by a firewall of an external domain.

11. The system as claimed in claim 8, further comprising a plurality of dedicated application gateways for communicating between the device and a plurality of external back-end services.

12. The system topology as claimed in claim 11, wherein the dedicated application gateways are protected by external domain firewalls.

13. A computer-readable medium storing instructions or statements for use in the execution in a computer of a method of providing secure end-to-end communication between a wireless device and an application data source, the method comprising the steps of:
receiving instructions to send a communication message from a wireless or mobile device to a back-end service;
determining whether the application calling the back-end service is associated with a dedicated application gateway;
sending the communication messages via a default application gateway if the application is not associated with the dedicated application gateway; and
sending the communication messages via the dedicated application gateway if the application is associated with the dedicated application gateway.

14. A propagated signal carrier carrying signals containing computer-executable instructions that can be read and executed by a computer, the computer-executable instructions being used to execute a method of providing secure end-to-end communication between a wireless device and an application data source, the method comprising the steps of:
receiving instructions to send a communication message from a wireless or mobile device to a back-end service;
determining whether the application calling the back-end service is associated with a dedicated application gateway;
sending the communication messages via a default application gateway if the application is not associated with the dedicated application gateway; and
sending the communication messages via the dedicated application gateway if the application is associated with the dedicated application gateway.
